(19) United States
(12) Patent Application Publication
(10) Pub. No.: US 2012/0308894 A1
(43) Pub. Date: Dec. 6, 2012

(54) POWER STORAGE DEVICE AND METHOD OF MANUFACTURING THE SAME

(75) Inventors: Teppei Oguni, Atsugi (JP); Takeshi Osada, Isehara (JP); Toshihiko Takeuchi, Atsugi (JP); Kuniharu Nomoto, Saitama (JP); Kiyofumi Ogino, Isehara (JP); Hiroatsu Todoriki, Atsugi (JP); Junpei Momo, Sagamihara (JP); Nobuhiro Inoue, Atsugi (JP)

(73) Assignee: SEMICONDUCTOR ENERGY LABORATORY CO., LTD, Atsugi-shi (JP)

(21) Appl. No.: 13/484,299

(22) Filed: May 31, 2012

(30) Foreign Application Priority Data
Jun. 3, 2011 (JP) 2011-125224
Jun. 24, 2011 (JP) 2011-140307

(51) Int. Cl. H01M 4/583; H01G 7/00; H01G 9/04; H01M 4/04

(52) U.S. Cl. 429/231.8; 29/623.5; 29/25.41; 361/528

(57) ABSTRACT

A negative electrode and a power storage device are provided, which have one of an alloy-based particle and an alloy-based whisker and a carbon film including 1 to 50 graphene layers. A surface of the alloy-based particle or the alloy-based whisker is covered with the carbon film. In addition, a method of manufacturing a negative electrode and a method of manufacturing a power storage device are provided, which have the step of mixing an alloy-based particle or an alloy-based whisker with graphene oxide, and the step of heating the mixture in a vacuum or in a reducing atmosphere.

### BACKGROUND OF THE INVENTION

1. Field of the Invention

The present invention relates to a material and an electrode which are used for a power storage device such as a secondary battery or a capacitor. The present invention particularly relates to a power storage device formed using a particulate alloy-based negative electrode material, especially, a negative electrode material for a lithium-ion secondary battery and a lithium-ion secondary battery formed using the negative electrode material.

2. Description of the Related Art

Graphite is widely used as a negative electrode material for a lithium-ion secondary battery. However, the theoretical discharge capacity per unit mass of graphite is only 372 mAh/g because one lithium atom is bound to six carbon atoms. Lithium ions are occluded by graphite by being inserted between layers of graphite.

In order to overcome this limit, as a negative material for a lithium-ion secondary battery, the use of silicon, germanium, aluminum, or tin (which is referred to as an alloy-based negative electrode material) is under consideration. The theoretical discharge capacity per unit mass of a silicon-based negative electrode material is 4210 mAh/g which is significantly high because four lithium atoms are bound to one silicon atom.

However, the alloy-based negative electrode material occludes lithium by forming an alloy with lithium and therefore has a drastic particle volume change due to charging and discharging, which causes, the problem of degradation of battery characteristics (e.g., see Patent Document 1). In order to avoid this problem, it is necessary to use fine particles of an alloy-based negative electrode material with an average particle size of less than or equal to 250 nm, preferably more than or equal to 20 nm and less than or equal to 100 nm. Note that the particle size is the size of a primary particle.

It is known that during charging and discharging, the alloy-based negative electrode material and an electrolyte react with each other to for a compound film which is a decomposition product of the electrolyte over an electrode surface. Such a compound film is referred to as a solid electrolyte interface (SEI) and is considered necessary for stabilization with a suppressed reaction, between the electrode and the electrolyte. However, the thickness is determined by a combination of the electrode and the electrolyte and therefore may become larger than necessary.

Examples of adverse effects, of SEI formation include a decrease in coulombic efficiency, a decrease in the lithium ion conductivity between the electrode and the electrolyte, consumption of the electrolyte, and the like.

The alloy-based negative electrode material in the form of particles as described above is formed over a current collector; a binder is needed to bind the particles. A general binder is a polymer organic compound with extremely low conductivity. Thus, a binder may cause an increase the internal resistance of a battery.

In a general conventional electrode, the proportion of a material other than the alloy-based negative electrode material that is an active material has been 15% or higher. To increase the capacity of a battery, it is necessary to reduce the weight or volume of the material other than the active material. It is also necessary to take measures to prevent the material other than the active material (especially binder) from swelling by absorbing the electrolyte because the swelling might cause deformation or breakdown of the electrode.

Furthermore, when alloy-based negative electrode material particles have an average particle size of 250 nm or less, it is difficult to evenly disperse the alloy-based negative electrode material particles and, a conduction auxiliary agent in a binder, and a larger binder is needed. This causes a decrease in the weight, proportion of an active material in the electrode and in increase in internal resistance.

FIG. 1B is a schematic cross-sectional view of an electrode including an alloy-based negative electrode material. Microparticles of alloy-based negative electrode material particles are likely to aggregate and unlikely to be dispersed in a binder uniformly. Therefore, a portion where alloy-based negative electrode material particles are concentrated (portion where the alloy-based negative electrode material particles aggregate) and a portion where alloy-based negative electrode material particles are thinly distributed are generated, resulting in a reduction in the proportion of the active material in the electrode. Further, the portion where the alloy-based negative electrode material particles are concentrated includes a portion where a conduction auxiliary agent does not exist, so that the conductivity in that portion is low and alloy-based negative electrode material particles that cannot contribute to capacity are generated.

### REFERENCES

[Patent Document 1] United States Patent Application Publication No, 2009/0253945
[Patent Document 2] United States Patent Application Publication No. 2007/0131915

### SUMMARY OF THE INVENTION

In order to solve these problems, it is an object of one embodiment of the present invention to provide a power storage device with suppressed degradation of battery characteristics due to a volume change of alloy-based negative electrode material particles in charging and, discharging. It is an object of one embodiment of the present invention to provide a power storage device with SEI formation suppressed.

It is an object of one embodiment of the present invention to provide a power storage device with excellent charging and discharging characteristics. It is an object to provide a power storage device which has high reliability and can withstand long-term or repeated use. The present invention achieves at least one of the above objects.

One embodiment of the present invention is a power storage device which includes, as a negative electrode, an alloy-based negative electrode material particle or an alloy-based negative electrode material whisker with a surface covered with a carbon film including 1 to 50 graphene layers, preferably 1 to 20 graphene layers. The carbon film has at least one hole. The carbon film may be net-like graphene (graphene net).

FIG. 1A is a schematic cross-sectional view of an electrode including graphene nets each having such an expansion. In FIG. 1A, there is a plurality of graphene nets and a plurality of alloy-based negative electrode material particles, and the alloy-based negative electrode material particles tangle in the graphene nets, so that the alloy-based negative electrode material particles can be bonded to one another. Alternatively, the graphene nets are filled with the alloy-based negative electrode material particles.

The graphene net has a two-dimensional expansion and also includes a depression or projection, so that the graphene net partly has a bag-like shape. As described above, the graphene net is formed of limited number of graphene layers, and thus is very thin; accordingly, a cross-section thereof is linear.

By evenly mixing graphene nets with alloy-based negative electrode material particles, the distance between the alloy-based negative electrode material particles can be smaller than in the case of using an ordinary binder (FIG. 1B); thus, the electrode volume can be smaller. There is an appropriate space left among the alloy-based negative electrode material particles; this portion serves, as a buffer region for swelling of the alloy-based negative electrode material particles when the alloy-based negative electrode material particles occlude lithium.

Needless to say, the graphene net is also in contact with a current collector, thereby binding the current collector and the alloy-based negative electrode material particles. In that case, electricity can also be conducted between the current collector and the alloy-based negative electrode particles via the graphene net.

In this manner, the graphene net which has a two-dimensional expansion and whose thickness is negligible can serve as the binder. As a result, the content of the binder, which has been necessary so far, can be reduced. Depending on the case, an electrode can be formed without using the binder, which has been necessary so far. Therefore, the volume, proportion or the weight proportion of the active material in the electrode can be increased.

The graphene net has high flexibility and high mechanical strength. Further, since the graphene net includes the alloy-based negative electrode material particles as illustrated in FIG. 1A, the bond between the alloy-based negative electrode material particles can be maintained even when the volume of the alloy-based negative electrode material particles is increased and, decreased by charging and discharging.

Further, the graphene net hardly absorbs an electrolyte, so that the graphene net does not swell in the electrolyte. As a result, it is possible to suppress deformation or breakdown of the electrode.

Besides the graphene net, the electrode may include acetylene black particles having a volume 0.1 to 10 times as large as the graphene net carbon particles having a one-dimensional expansion (e.g., a carbon nanofiber), or other known binders.

In the above embodiment; the carbon film covering the alloy-based negative electrode material particle or the alloy-based negative electrode material whisker is preferably obtained by forming graphene oxide over a surface of the alloy-based negative electrode material particle or whisker and then reducing the graphene oxide. In the above embodiment, the proportion of elements in the carbon film is preferably 15 at. % or less. The proportion of elements other than carbon in the carbon film may be 30 at. % or less.

Mixing the carbon film with the alloy-based negative electrode material particles can increase at least one of the conductivity, a bond between the alloy-based negative electrode material particles, and dispersion of the particles. Note that in this specification, graphene refers to a one-atom-thick sheet of carbon molecules having sp² bonds. Further, graphite refers to plural graphene layers bonded to one another by the Van der Waals'force.

One embodiment of the present invention is a method of manufacturing a power storage device, which includes the steps of: mixing an alloy-based negative electrode material particle or an alloy-based negative electrode material whisker with a precursor of a carbon film (e.g., graphene oxide); and heating the mixture in a vacuum (100 Pa or less) or in a reducing atmosphere.

One embodiment of the present invention is a method of manufacturing a power storage device, which includes the steps of: immersing an alloy-based negative electrode material particle or an alloy based negative electrode material whisker in a solution in which a precursor of a carbon film is dispersed; and heating the alloy-based negative electrode material particle or the alloy-based negative electrode material whisker in a vacuum (100 Pa or less) or in a reducing atmosphere.

One embodiment of the present invention is a method of manufacturing a power storage device; which includes the steps of immersing an alloy-based negative electrode material particle or an alloy-based negative electrode material whisker and an electrode in a solution in which a precursor of a carbon film is dispersed, and applying a voltage between the alloy-based negative electrode material particle or the alloy-based negative electrode material whisker and the electrode; and heating the alloy-based negative electrode material particle or the alloy-based negative electrode material whisker in a vacuum (100 Pa or less) or reducing atmosphere.

At that time, the precursor does not particularly need to have a large expansion or be a high molecular compound, but precursors are bonded to each other in the heating step, resulting in polymerization or formation of a high molecule, formation of a larger, three-dimensional-carbon film network (graphene net).

Note that the graphene net in this specification does not necessarily have a two-dimensional structure in a strict sense, and may partly have a three-dimensional structure. For example, one graphene net can be formed by bonding a graphene to a portion of another graphene.

Note, that in the case where graphene oxide is used as a precursor of the graphene net in the above embodiment, graphene oxides, each having a side of 10 μm or less are preferably used. Such graphene oxides form a large-area carbon film by bonding together in the above heating step, and at that time, an appropriate hole and an appropriate gap are formed.

In the above embodiment, one or a plurality of layers of a material different from that of the carbon film may be formed over the surface of the alloy-based negative electrode material particle or the alloy-based negative electrode material whisker. Such a material layer preferably has high conductivity. The layer may further have high adhesion to both the alloy-based negative electrode material particle or the alloy-based negative electrode material whisker and the carbon film.

Furthermore, in the above embodiment, one or a plurality of layers of a material different from that of the carbon film may be formed over the carbon film. The carbon film may be formed over the layer of a material different from that of the carbon film. In that case, the layer of a material different from that of the carbon film preferably has a stress relaxation effect by which the carbon film is prevented from being separated.

In the above embodiment, another carbon film may be formed over the carbon film by further forming a layer of a precursor such as graphene oxide and reducing the precursor.

In any of the above embodiments, the carbon film covers the alloy-based negative electrode material particle or whisker. Therefore, even when the volume of the alloy-based negative electrode material particle or the alloy-based negative electrode material whisker is changed in charging and discharging, the alloy-based negative electrode material particle or the alloy-based negative electrode material whisker can be prevented from being fractured, and deterioration of the power storage device due to the volume change of the alloy-based negative electrode material particle in charging and discharging can be suppressed.

In particular, in the above embodiment, strong sp² bonds between molecules of the carbon film are substantially parallel to the alloy-based negative electrode material surface. Thus, the carbon film can be prevented from being broken even when the alloy-based negative electrode material swells. In addition, the carbon film has an appropriate hole and an appropriate gap and can stretch with the swelling of the alloy-based negative electrode material, and furthermore, such a hole and a gap allow lithium ions to pass through.

Note that a carbon film including 200 graphene layers or more may have the problem of low mechanical strength because the sp² bonds are not necessarily parallel to the alloy-based negative electrode material surface. The results of observation by the present inventors show that carbon films including 65 and 108 graphene layers, for example, are easily separated from an alloy-based negative electrode material surface, and the carbon film including 108 graphene layers is separated to a larger extent. On the other hand, no separation is seen in carbon films including 17 and 43 graphene layers.

Therefore, a carbon film including 51 graphene layers or more may be broken or separated with the swelling of an alloy-based negative electrode material, in which case the alloy-based negative electrode material swelled may be fractured. Note that this does not always apply to the case where a film of another material is formed over an alloy-based negative electrode material surface so as to increase the adhesion to the carbon film.

In order to obtain a more flexible carbon film, a carbon film including 20 graphene layers or less may be used. A carbon film having a high oxygen concentration is preferable, and a carbon film having an oxygen concentration of more than or equal to 5 at. % and less than or equal to 15 at. % may be used. Note that in the case where the conductivity of the carbon film has priority, a carbon film having a low oxygen concentration is preferable, and a carbon film having an oxygen concentration of less than or equal to 1 at. % may be used.

The above structure can increase the density of the electrode and reduce the resistance between the active material and the current collector. In particular, in a case of a battery, it is more preferable that the resistance (internal resistance) of an electrode be lower, which is suitable, for applications where, a large amount of power is required instantaneously. The above structure is suitably used to achieve that object.

For example, a power source of an electric vehicle consumes a relatively small amount of power when the electric vehicle is driven on flatland. However, a large amount of power is consumed under hard acceleration or in ascending a slope. In that case, the power source needs to feed a large amount of current; however, when internal resistance is high, a significant voltage drop and also a loss due to the internal resistance are caused. Further, in that case, the loss is increased when the weight of a battery is large.

As a result, part of the power which is expected to be available is lost under such circumstances. For example, when a secondary battery is used as the power supply, although stored power can be almost fully used if the vehicle is driven on flatland, part of the power is lost in ascending a slope or under acceleration. Such a loss can be suppressed by lowering the internal resistance and reducing the weight of the battery (or increasing the battery capacity).

### BRIEF DESCRIPTION OF THE DRAWINGS

FIG. 1A is a schematic cross-sectional view of an electrode according to one embodiment of the present invention, and FIG. 1B is a schematic cross-sectional view of an electrode.

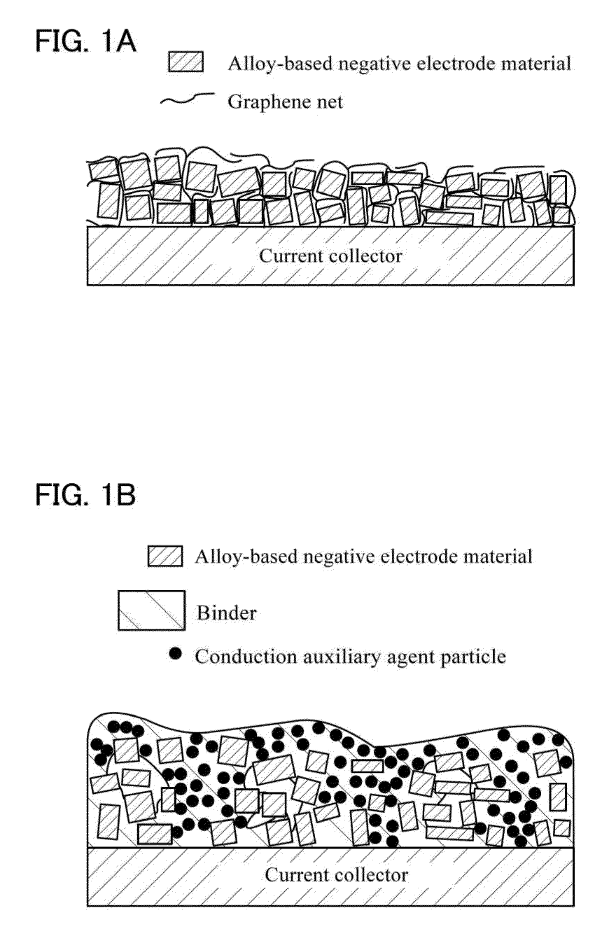

FIGS. 2A to 2D are diagrams for Example 1.

FIG. 3 is a diagram for Example 2.

FIGS. 4A and 4B illustrate characteristics of Sample A and Sample B in Example 3.

FIG. 5 illustrates an example of a power storage device.

FIG. 6 ilustrates a variety of applications of a power storage device.

FIGS. 7A and 7B are diagrams for Example 3.

FIG. 8A shows weight changes and heat flow changes of graphene oxide due to heat, and FIG. 8B shows the amount of released carbon dioxide.

FIG. 9 shows changes of infrared absorption spectra of graphene oxide due to heat.

### DETAILED DESCRIPTION OF THE INVENTION

Embodiments will be described below. Note that embodiments can be carried out in many different modes, and it is easily understood by those skilled in the art that modes and details of the present invention can be modified in various ways without departing from the spirit and the scope of the present invention. Therefore, the present invention should not be interpreted as being limited to the description in the following embodiments.

### Embodiment 1

In this embodiment, an example is described in which silicon is used as an alloy-based negative electrode material and a carbon film including 1 to 50 graphene layers is formed over surfaces of silicon particles. First, graphite oxide is prepared by oxidizing graphite and then subjected to ultrasonic vibration to give graphene oxide. For details, Patent Document 2 may be referred to. Alternatively, commercially available graphene oxide may be used. Graphene oxide may be obtained from graphite in the following manner.

First, graphite such as flake graphite is oxidized to give graphite oxide. The graphite oxide refers to graphite which is oxidized in places and to which a functional group such as a carbonyl group, a carboxyl group, or a hydroxyl group is bonded. In the graphite oxide, the crystalliinity of the graphite is lost and the distance between graphenes is increased. Therefore, graphite oxide layers are easily separated from each other by ultrasonic treatment or the like.

As a result, graphene oxide in which 1 to 50 carbon sheets corresponding to graphene are stacked is obtained. Note that the periphery of graphene oxide is terminated by a functional group, whereby the graphene oxide can be suspended in a polar solvent such as water, chloroform, N,N-dimethylformamide (DMF), or N-methylpyrrolidone (NMP). The solution containing the graphene oxide which has been subjected to the ultrisonic treatment is dried to give graphene oxide powder.

Next, the graphene oxide is mixed with silicon particles. The proportion of graphene oxide may be set in the range from 1 wt. % to 15 wt. %, preferably from 1 wt. % to 5 wt. % of the total. Note that a layer of a highly conductive material such as copper may be formed in advance over a surface of each silicon particle. The average size of the silicon particles is less than or equal to 250 nm, preferably in the range from 20 nm to 100 nm.

Further, the mixture is heated at 150° C. or higher; preferably 200° C. or higher in a vacuum or in a reducing atmosphere such as an inert gas (nitrogen, a rare gas, or the like) atmosphere. Depending on the temperature, the heating may be performed in the air. By being heated at a higher temperature and for a longer time, graphene oxide is reduced to a higher extent so that graphene with high purity (i.e., with a low concentration of elements other than carbon) can be obtained. Note that graphene oxide is known to be reduced at 1-50° C.

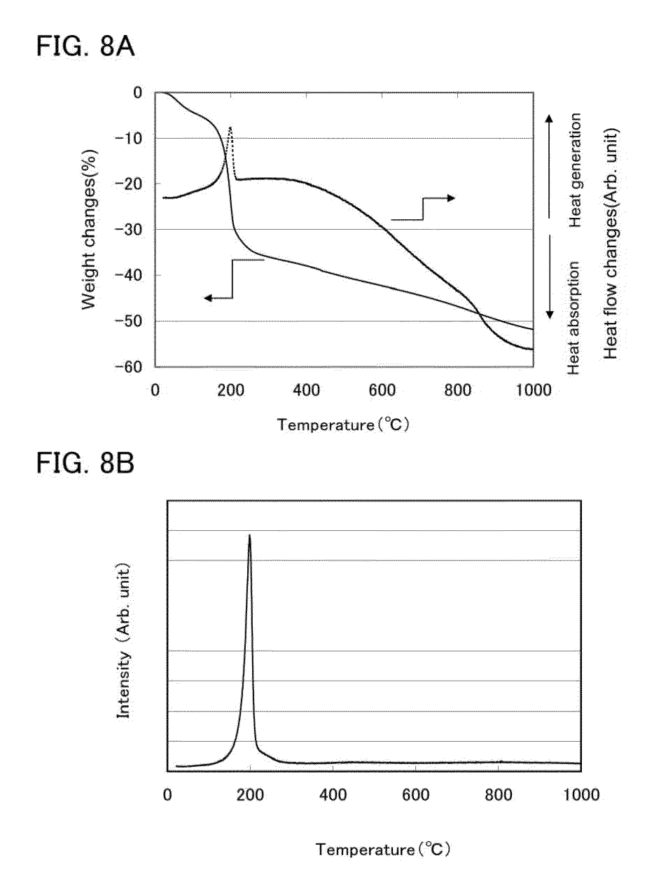

FIG. 8A shows weight changes (solid line) and heat flow changes (dotted line) of graphene oxide which is formed in the above manner and heated in a reducing atmosphere (in a helium atmosphere) from room temperature to 1000° C. at a temperature rising rate of 2° C./min. A heat generation peak accompanied by a significant reduction in weight is seen at around 200° C., indicating a certain chemical change.

Molecules released in the above measurement are analyzed by mass spectrometry. From the results, FIG. 8B shows the amount of released molecules having a mass number of 44 (presumed to be carbon dioxide). An immediate release of molecules having a mass number of 44 is also seen at around 200° C.

Although not shown in FIGS. 8A and 8B, significantly large amounts of molecules having a mass number of 12 (carbon atoms which might have been generated by decomposition of molecules containing carbon in the mass spectrometry), molecules having a mass number of 16 (presumed to be oxygen atoms), and molecules having a mass number of 18 (presumed to be water) are also seen at around 200° C., indicating that oxygen and hydrogen as well as carbon are released from the graphene oxide at this temperature, in other words, it is indicated that reduction occurs at this temperature.

Since graphite is treated with sulfuric acid for oxidation, a sulfone group and the like are also bonded to the multilayer graphene oxide, and its decomposition (release) turns out to start at around 200° C. to 300° C. Therefore, graphene oxide is preferably reduced at 200° C. or higher, more preferably 300° C. or higher.

Higher temperature enhances the reduction and increases the proportion of carbon in the graphene net to be formed. Further, more defects are repaired and the conductivity is enhanced. Note that high-temperature treatment is preferable in order to obtain graphene having high electron conductivity. For example, the resistivity of multilayer graphene is approximately 240MΩ·cm at a heating temperature of 100° C. (for 1 hour), approximately 4 kΩ·cm at a heating temperature of 200° C. (for 1 hour), and approximately 2.8 Ω·cm at a heating temperature of 300° C. (for 1 hour).

In this manner, graphene oxide formed over the surfaces of the silicon particles is reduced to produce a carbon film including graphene layers. At that time, adjacent graphenes are bonded to each other to form a huge net-like or sheet-like network (graphene net). The carbon film formed in this manner has an appropriate hole and an appropriate gap.

The silicon particles having been subjected to the above treatments are dispersed in an appropriate solvent (preferably a polar solvent such as water, chloroform, N,N-dimethylformamide (DMF), or N-methylpyrrolidone (NMP)) to obtain a slurry. A secondary battery can be manufactured using the slurry.

Alternatively, a slurry in which silicon particles and graphene oxide are mixed may be prepared and applied to a current collector, and then the graphene oxide may be reduced. The silicon particles and graphene oxide are preferably mixed such that the proportion of the silicon particles is 90 wt. % or more, preferably 95 wt. % or more of the mixture.

Before the mixing, only graphene oxide may be suspended in a solvent such as water or NMP. After that, the silicon particles are mixed into the suspension to give a slurry. Another conduction-auxiliary agent such as acetylene black or a binder may be additionally mixed as appropriate.

The obtained slurry is applied to a current collector. The thickness can be set as appropriate, and is preferably 1 μm to 1 mm. Then, the slurry is dried. The drying may be followed by pressing as needed.

After that, the graphene oxide is reduced in a vacuum or in a reducing atmosphere. At this time, graphene nets are formed and silicon particles are tangled in the graphene nets, resulting in higher bonding strength between the silicon particles. In other words, the graphene nets function as a binder.

Depending on the reduction temperature, the conductivity of the carbon film (graphene nets) changes as described above; in addition, its flexibility, strength, and the like also change. The reduction temperature may be set in accordance with the required conductivity, flexibility, strength, and the like. In the case where the conductivity of graphene nets used as a binder is not sufficiently high, a required amount of a known conduction auxiliary agent is preferably added so as to increase the conductivity.

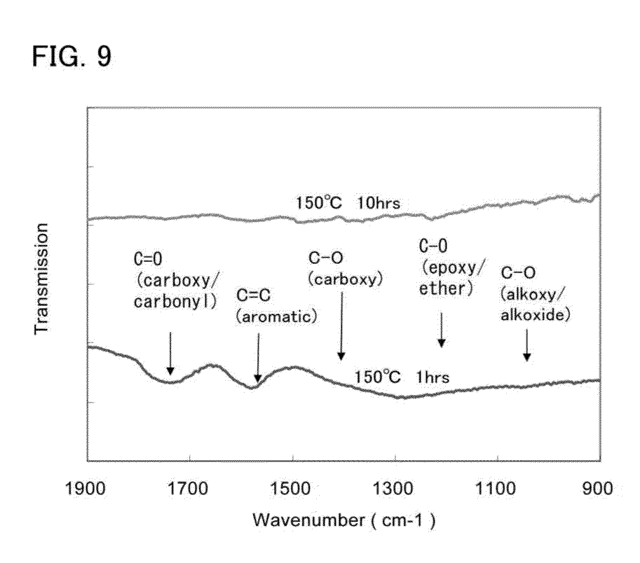

As a result of inventors' examinations, it has turned out that a long-time heating treatment even at 150° C., enhances reduction. FIG. 9 shows results of infrared spectroscopy (tranismittances) in the cases where graphene oxide is heated at 150° C. for 1 hour and for 10 hours. In the case where the heating at 150° C. is performed only for 1 hour, much absorption occurs due to a C=O bond, a C═C bond, a C—O bond, and the like. In contrast, in the case where the heating at 150° C. is performed for 10 hours, less absorption occurs due to the above carbon and oxygen bonds.

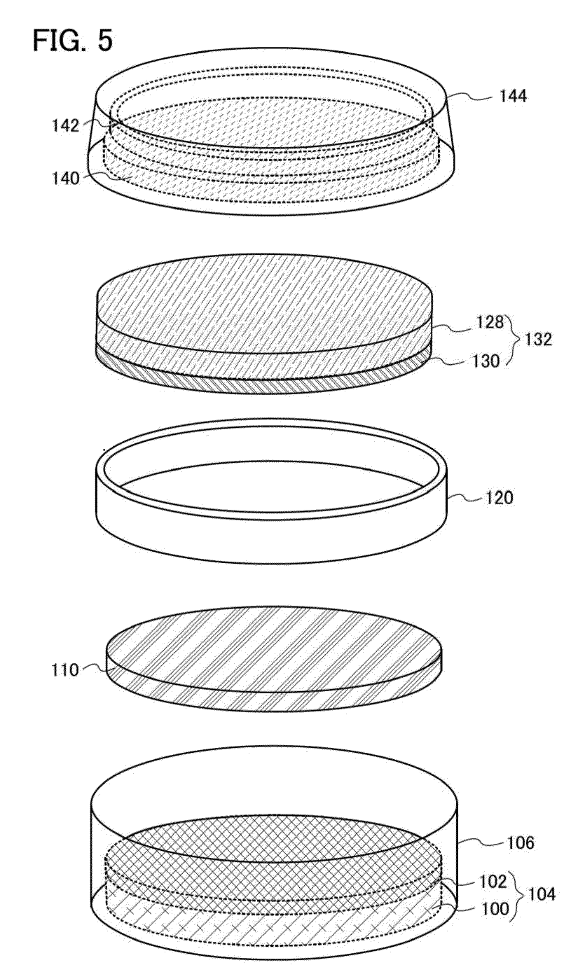

FIG. 5 is a schematic view illustrating the structure of a coin-type secondary battery. As illustrated in FIG. 5, the coin-type secondary battery includes a negative electrode 104, a positive electrode 132, a separator 110, an electrolyte (not illustrated), a housing 106, and a housing 144. Besides, the coin-type secondary battery includes a ring-shaped insulator 120, a spacer 140, and a washer 142.

The negative electrode 104 includes a negative electrode active material layer 102 over a negative electrode current collector 100. As the negative electrode current collector 100, copper may be used, for example. The negative electrode active material layer 102 is preferably formed using, as a negative electrode active material, the above-described slurry alone or in combination with a binder.

As a material for the positive electrode current collector 128, aluminum is preferably used. A positive electrode active material layer 130 may be obtained by applying a slurry; in which positive electrode active material particles are mixed together with a binder and a conduction auxiliary agent, to the positive electrode current collector 128 and then drying the slurry.

Examples of the positive electrode active material include, but are not limited to, lithium cobaltate, lithium iron phosphate, lithium manganese phosphate, lithium manganese silicate, and lithium iron silicate. The size of the active material particles is preferably 20 nm to 100 nm. Further, a carbohydrate such as glucose may be mixed at the time of manufacturing the positive, electrode active material so that the positive electrode active-material particles are coated with carbon. This treatment can improve the conductivity.

It is preferable to use, without limitation, an electrolyte in which LiPF₆ is dissolved in a mixed solvent of ethylene carbonate (EC) and diethyl carbonate (DEC).

An insulator with pores (e.g., polypropylene) may be used for the separator 110. Alternatively, a solid electrolyte which can transmit lithium ions may be used.

The housing 106, the housing 144, the spacer 140, and the washer 142, each of which is made of metal (e.g., stainless steel) are preferably used. The housing 106 and the housing 144 have a function of electrically connecting the negative electrode 104 and the positive electrode 132 to the outside.

The negative electrode 104, the positive electrode 132, and the separator 110 are immersed in the electrolyte. Then, as illustrated in FIG. 5, the negative electrode 104, the separator 110, the ring-shaped insulator 120, the positive electrode 132, the spacer 140, the washer 142, and the housing 144 are stacked in this order with the housing 106 positioned at the bottom. The housing 106 and the housing 144 are subjected to pressure bonding. In such a manner, the coin-type lithium-ion secondary battery is manufactured.

Although silicon is given as an example of the alloy-based negative electrode material in this embodiment, the present invention can be similarly carried out with other alloy-based negative electrode materials.

### Embodiment 2

In this embodiment, an example is described in which a carbon film including 1 to 50 graphene layers is formed over a surface of a silicon active material layer formed over a current collector. First, graphene oxide is dispersed in a solvent such as water or NMP. The solvent is preferably a polar solvent. The concentration of graphene oxide may be 0.1 g to 10 g per liter.

A current collector with a silicon active material layer is immersed in, this solution, taken out, and then dried. Note that a layer of a highly conductive material such as copper may be formed in advance over a surface of the silicon active material layer. Further, the current collector with the silicon active material layer is heated at 150° C. or higher, preferably 200° C. or higher in a vacuum or in a reducing atmosphere such as an inert gas (nitrogen, a rare gas, or the like) atmosphere. Through the above process, a carbon film including 1 to 50 graphene layers can be formed over a surface of the silicon active material layer.

Note that after one carbon film is formed in the above manner, the same process may be repeated to further form a carbon film including 1 to 50 graphene layers in a similar manner. The process may be repeated three or more times. A multi-layer carbon film formed in such a manner has higher strength; thus, a break thereof due to swelling of silicon can be further suppressed.

In the case where a thick carbon film is formed at a time, the direction of the sp² bonds, in the carbon film is disordered, and the strength of the carbon film is not proportional to the thickness. On the other hand, in the case where a carbon film is formed through a plurality of steps as described above, the sp² bonds in the carbon film are substantially parallel to a silicon surface and therefore the strength of the carbon film increases as the thickness increases.

### Embodiment 3

In this embodiment, another example is described in which a carbon film including 1 to 50 graphene layers is formed over a surface of a silicon active material layer formed over a current collector. As in Embodiment 2, graphene oxide is dispersed in a solvent such as water or NMP. The concentration of graphene oxide may be 0.1 g to 10 g per liter.

A current collector provided with a silicon active material layer is put in the solution in which graphene oxide is dispersed, and this is used as an anode. Note that a layer of a highly conductive material such as copper may be formed in advance over a surface of the silicon active material layer. A conductor serving as a cathode is put in the solution, and an appropriate voltage (e.g., 5 V to 20 V) is applied between the anode and the cathode. In graphene oxide, part of an edge of a graphene sheet with a certain size is terminated by a carboxyl group (—COOH), and therefore, in a solvent such as water, hydrogen ions are released from the carboxyl group and graphene oxide itself is negatively charged and thus attracted to and deposited onto the anode. Note that the voltage does not need to be constant. By measurement of the amount of electric charge flowing between the anode and the cathode, the thickness of a layer of graphene oxide deposited on the silicon active material layer can be estimated.

When a graphene oxide with a necessary thickness is obtained, the current collector is taken out of the solution and dried. Further, the current collector with the graphene oxide is heated at 150° C. or higher, preferably 200° C., or higher in a vacuum or in a reducing atmosphere such as an inert gas (nitrogen, a rare gas, or the like) atmosphere. Depending on the temperature, the heating may be performed in the air. In this manner, the graphene oxide formed over the surface of the silicon active material is reduced to graphene. At that time, adjacent graphenes are bonded to each other to form a huge net-like or sheet-like network (graphene net).

Even when the silicon active material has projections and depressions, the thus formed graphene has a substantially uniform thickness even at the projections and depressions. In this manner, a carbon film including 1 to 50 graphene layers can be formed over the surface of the silicon active material layer.

Note that after the carbon film is formed in the above manner, the formation of a carbon film by the method of this embodiment or the formation of a carbon film by the method of Embodiment 2 may be performed twice or more.

### Embodiment 4

The power storage device according to one embodiment of the present invention can be used in, for example, electric vehicles, electric power tools, personal computers, mobile phones, emergency power-supplies, and the like. Such an electric device is not always supplied with power by a wire and therefore includes a storage battery inside. As an active material of a negative electrode of the storage battery, silicon particles or whiskers with surfaces covered with the carbon film including a graphene layer described in any of Embodiments 1 to 3, for example, may be used.

In addition, specific examples of electronic and electric devices including the power storage device according to one embodiment of the present invention are as follows: display devices, lighting devices, image reproduction devices which reproduce a still image or a moving image stored in a recording medium such as a digital versatile disc (DVD), high-frequency heating apparatus such as microwaves, electric-rice cookers, electric washing machines, air-conditioning systems such as air conditioners, electric refrigerators, electric freezers electric, refrigerator-freezers, freezers for preserving DNA, dialysis devices, and the like.

In addition, moving objects driven by an electric motor using electric power from a power storage device are also included in the category of electronic and electric devices. As, examples of the moving objects, electric vehicles, hybrid vehicles which include both an internal-combustion engine and a motor, motorized bicycles including motor-assisted bicycles, and the like can be given.

In the electronic and electric devices, the power storage device according to one embodiment of the present invention can be used as a power storage device for supplying enough electric power for almost the whole power, consumption (referred to as a main power supply). Alternatively, in the electronic and electric devices, the power storage device according to one embodiment of the present invention can be used as a power storage device which can supply electric power to the electronic and electric devices when the supply of power from a commercial power supply is stopped (such a power storage device is referred to as an uninterruptible power supply).

Further alternatively, in the electronic and electric devices, the power storage device according to one embodiment of the present invention can be used as a power storage device for supplying electric power to the electronic and electric devices at the same time as the electric power supply from the main power supply or a commercial power supply (such a power storage device is referred to as an auxiliary power supply).

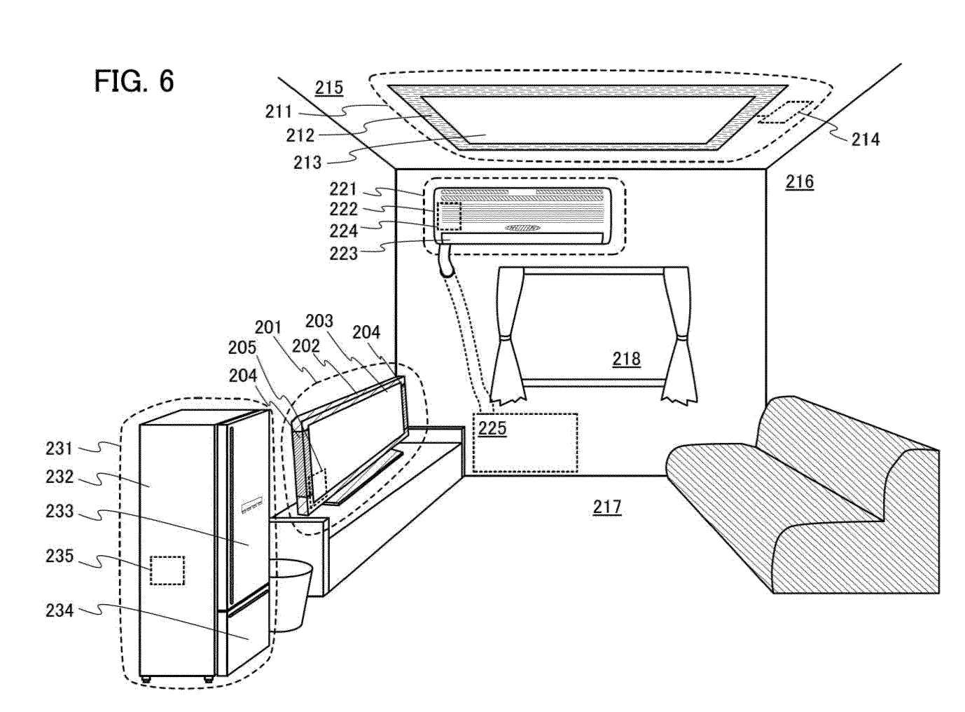

FIG. 6 shows specific structures of the electronic and electric devices. In FIG. 6, a display device 201 is an example of an electronic or electric device including a power storage device 205 according to one embodiment of the present invention. Specifically, the display device 201 corresponds to a display device for TV broadcast reception and includes a housing 202, a display portion 203, speaker portions 204, the power storage device 205, and the like. The power storage device 205 according to one embodiment of the present invention is provided inside the housing 202.

The display device 201 can receive electric power from a commercial power supply. Alternatively, the display device 201 can use electric power stored in the power storage device 205. Thus, the display device 201 can be operated with the use of the power-storage device 205 according, to one embodiment of the present invention as an uninterruptible power supply even when electric power cannot be supplied from the commercial power supply because of power failure or the like.

A semiconductor display device such as a liquid crystal display device, a light-emitting device in which a light-emitting element such as an organic EL element is provided in each pixel, an electrophoresis display device, a-digital micromirror device (DMD), a plasma display panel (PDP), a field emission display (FED), and the like can be used in the display portion 203.

Note that the display device includes, in its category, all of information display devices for personal computers, advertisement, displays, and the like besides TV broadcast reception.

In FIG. 6, an installation lighting device 211 is an example of an electric device including a power storage device 214 according to one embodiment of the present invention. Specifically, the lighting device 211 includes a housing 212, a light source 213, the power storage device 214, and the like. FIG. 6 shows the case where the power storage device 214 is provided in a ceiling 215 on which the housing 212 and the light source 213 are installed; alternatively, the power storage device 214 may be provided in the housing 212.

The lighting device 211 can receive electric power from the commercial power supply. Alternatively, the lighting device 211 can use electric power stored in the power storage device 214. Thus, the lighting device 211 can be operated with the use of the power storage device 214 according to one embodiment of the present invention as an uninterruptible power supply even when electric power cannot be supplied from the commercial power supply because of power failure or the like.

Note that although the installation lighting device 211 provided in the ceiling 215 is shown in FIG. 6 as an example, the power storage device according to one embodiment of the present invention can be used in an installation lighting device provided in, for example, a wall 216, a floor 217, a window 218, or the like other than the ceiling 215. Alternatively, the power storage device can be used in a tabletop lighting device and the like.

As the light source 213, an artificial light source which provides light artificially by using electric power can be used. Specifically, discharge lamps such as an incandescent lamp and a fluorescent lamp, and light-emitting elements such as an LED and an organic EL element are given as examples of the artificial light source.

In FIG. 6, an air conditioner including an indoor unit 221 and an outdoor unit 225 is an example of an electric device, including a power storage device 224 according to one embodiment of the present invention. Specifically, the indoor unit 221 includes a housing 222, a ventilation duct 223, the power storage device 224, and the like. FIG. 6 shows the case where the power storage device 224 is provided in the indoor unit 221; alternatively, the power storage device 224 may be provided in the outdoor unit 225. Further alternatively, the power storage devices 224 may be provided in both the indoor unit 221 and the outdoor unit 225.

The air conditioner can receive electric power from the commercial power supply. Alternatively, the air conditioner can use electric power stored in the power storage device 224. Specifically, in the case where the power storage devices 224 are provided in both the indoor unit 221 and the outdoor unit 225, the air conditioner can be operated with the use of the power storage device 224 according to one embodiment of be present invention as in uninterruptible power supply even when electric power cannot be supplied from the commercial power supply because of power failure or the like.

Note that although the separated air conditioner including the indoor unit and the outdoor unit is shown in FIG. 6 as an example, the power storage device according to one embodiment of the present invention can be used in an air conditioner in which the functions of an indoor unit and an outdoor unit are integrated in one housing.

In FIG. 6, an electric refrigerator-freezer 231 is an example of an electric device including a power storage device 235 according to one embodiment of the present invention. Specifically, the electric refrigerator-freezer 231 includes a housing 232, a refrigerator door 233, a freezer door 234, the power storage device 235, and the like. The power storage device 235 is provided in the housing 232 in FIG. 6. The electric refrigerator-freezer 231 can receive power from the commercial power supply. Alternatively, the electric refrigerator-freezer 231 can use electric power stored in the power storage device 235. Thus, the electric refrigerator-freezer 231 can be operated with the use of the power storage device 235 according to one embodiment of the present invention as an uninterruptible power supply even when electric power cannot be supplied from the commercial power supply because of power failure or the like.

Note that among the electronic and electric devices described above, a high-frequency heating apparatus such as a microwave and an electric device such as an electric rice cooker require, high electric power in a short time. The tripping of a circuit breaker of a commercial power supply in use of electric devices can be prevented by using the power storage device according to one, embodiment of the present invention as an auxiliary power supply for supplying electric power which cannot be supplied enough by a commercial power supply.

In addition, in a time period when electronic and electric devices are not used, specifically when a rate of actual use of electric power with respect to the total amount of electric power which can be supplied by a commercial power supply source (such a rate referred to as a usage rate of electric power) is low, electric power can be stored in the power storage device, whereby the usage rate of electric power can be reduced in a time period when the electronic and electric devices are used. In the case of the electric refrigerator-freezer 231, electric power can be stored in the power storage device 235 at night time when the temperature is low and the refrigerator door 233 and the freezer door 234 are, not opened or closed. Meanwhile the power storage device 235 is used as an auxiliary power supply in daytime when the temperature is high and the refrigerator door 233 and the freezer door 234 are opened and closed; thus, the usage rate of electric power in daytime can be reduced.

### Example 1

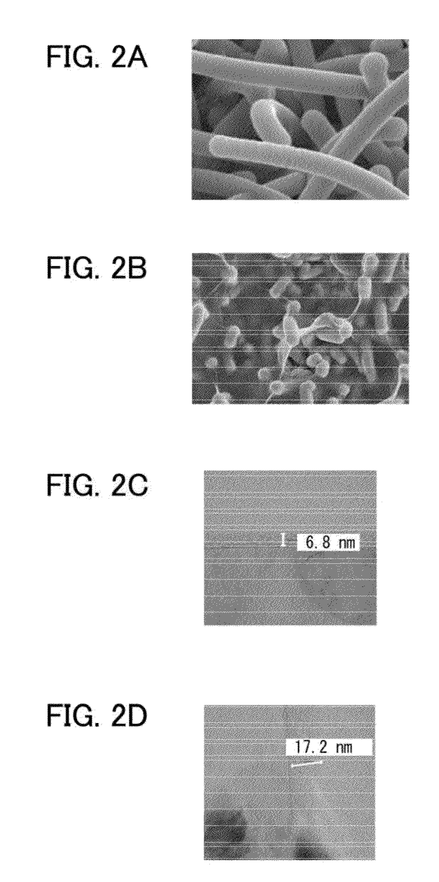

In this example, a sample in which graphene is formed over a surface of whisker-like silicon by the immersion method described in Embodiment 2 will be described. The whisker-like silicon is formed over a current collector (titanium sheet) and has a surface shape illustrated in FIG. 2A.

An aqueous solution in which graphene oxide is dispersed was manufactured as described below. Potassium permanganate was added to a mixture of graphite (flake carbon) and concentrated sulfuric acid, followed by stirring for 2 hours. After that, pure water was added to the mixture, the mixture was stirred for 15 minutes while being heated, and a hydrogen peroxide solution was added thereto, so that a yellow-brown solution containing graphite oxide was obtained. Furthermore, the obtained solution was filtered, and hydrochloric acid was added, followed by washing with pure water. After that, ultrasonic treatment was performed for 2 hours so that the graphite oxide was changed into graphene oxide, and an aqueous solution in which graphene oxide was dispersed was obtained.

After that, the titanium sheet with the above-described whisker-like silicon was immersed in the aqueous solution, and then taken out of the solution. The titanium sheet with the whisker-like silicon was dried and heated at 300° C. in a vacuum (0.1 Pa or less) for 10 hours. FIG. 2B shows an observed surface of the sample manufactured in this manner.

As shown in FIG. 2B, a depression of the whisker-like-silicon discovered with a graphene layer. FIG. 2B also shows that the graphene layer is formed so as to connect projections of the whisker-like silicon.

Cross-sectional TEM observation was performed in order to see how thick the graphene covering the whisker-like silicon was. Cross sections, of two portions were observed. In a portion shown in FIG. 2C, the thickness of the graphene was 6.8 nm; in a portion shown in FIG. 2D, the thickness of the graphene was 172 nm.

### Example 2

In this example, a sample in which graphene is formed over a surface of whisker-like silicon, by the electrophoresis method described in Embodiment 3 will be described. The whisker-like silicon used in this example is the same as that used in Example 1. The aqueous solution of graphene oxide prepared in this example is the same as that used in Example 1.

A titanium sheet with the whisker-like silicon was immersed in the aqueous solution, and a stainless steel plate was immersed therein, as another electrode. The distance between the titanium sheet and the stainless steel plate was about 1 cm. Then, with the titanium sheet used as an anode and the stainless steel plate as a cathode, a voltage of 10 V was applied between the anode and the cathode for 5 minutes. The amount of charge flowing during the 5 minutes was 0.114 C.

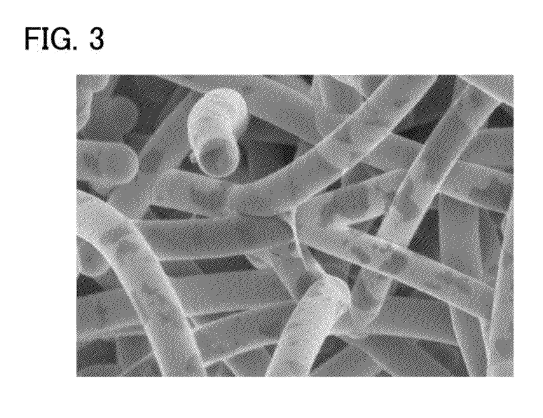

After that, the titanium sheet was taken out of the solution, dried, and then heated at 300° C. in a vacuum (0.1. Pa or less) for 10 hours. In such a manner, the sample was manufactured. FIG. 3 shows an observed surface of the obtained whisker-like silicon. Although a noticeable difference from the initial state (FIG. 2A) is not seen, a film-like object connecting whisker is seen in the central part of the image. In addition, dark portions are seen in places on the surfaces of the whiskers. The dark portions are possibly graphene with a large thickness.

Peaks of a D band and a G band, which are characteristics of graphene, were seen in any portion of the whiskers in measurements by Raman spectroscopy. This shows that substantially the entire surfaces of the whiskers are probably covered with graphene.

In the electrophoresis method, the thickness of the graphene layer can be controlled with the amount of charge; thus, the electrophoresis method has extremely high reproducibility. As described above, the graphene layer formed by the electrophoresis method described in Embodiment 3 can be extremely uniform.

### Example 3

In this example, comparison is made between the case where whisker-like silicon whose surface was provided with graphene was used as a negative electrode of a lithium-ion secondary battery and the case where whisker-like silicon whose surface was not provided with anything was used as a negative electrode of a lithium-ion secondary battery. It is known that an electrolyte used in the lithium-ion secondary battery is reacted with a silicon negative electrode, so that an SEI is formed on a surface of the electrode.

In this example, two kinds of samples, Sample A and Sample B, were prepared. Sample A is whisker-like silicon whose surface was not provided with anything and had an initial state of the surface similar to that of the whisker-like silicon shown in FIG. 2A. Sample B is whisker-like silicon whose surface was provided with graphene by the method described in Example 2 and had an initial state of the surface similar to that of the whisker-like silicon shown in FIG. 3.

Then, cyclic voltammetry measurement (CV measurement) was performed once on each of Sample A and Sample B to observe the surface of each whisker-like silicon. The CV measurement was performed at a scan rate of 0.1 mV/sec using a three-electrode beaker cell (working electrode: Sample A or Sample B, reference electrode metallic lithium, counter electrode: metallic, lithium, electrolyte: mixed solution of ethylene carbonate (EC) solution 1 mol/L) of lithium hexafluorophosphate (LiPF₆) and diethyl carbonate (DEC) (1:1 in volume ratio)).

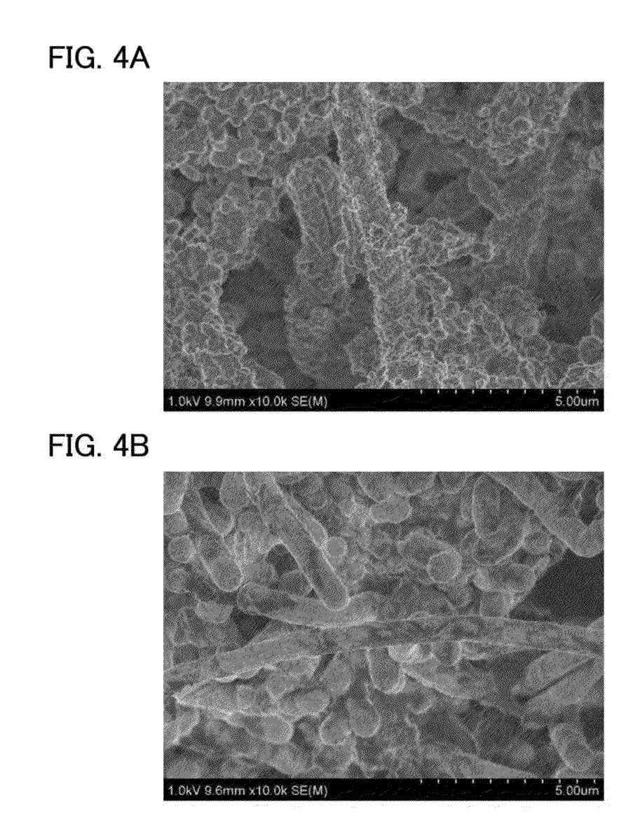

FIG. 4A shows the surface of Sample A after being subjected to one cycle of the above-described CV measurement (scan range: 0 V to 1 V (vs. Li/Li⁺)). FIG. 4B shows the surface of Sample B after being subjected to ten cycles of the above-described CV measurement (scan range: 0 V to 1 V (vs. Li/Li⁺)).

As is clear from the comparison between FIG. 4A and FIG. 2A, a thick SEI is formed on the surface of Sample A and it is difficult to see the shape of the original whisker-like silicon. In contrast, as is clear from the comparison between FIG. 4B and FIG. 3 or between FIG. 4B and FIG. 4A, an SEI formed on the surface of Sample B was not as thick as the SEI formed on the surface of Sample A.

A coin cell was manufactured using Sample A or Sample B as a positive electrode, metallic lithium as a negative electrode, a mixed solution of an ethylene carbonate (EC) solution (1 mol/L) of lithium hexafluorophosphate (LiPF₆) and diethyl carbonate (DEC) (1:1 in volume ratio) as an electrolyte, and polypropylene with minute holes as a separator. Then, the coin cell was charged and discharged to measure the amount of change in capacity associated with discharge and absorption of lithium. The amount of current in the charging and discharging was set to 50 μA for the first cycle and 4 mA for the second cycle and the subsequent cycles.

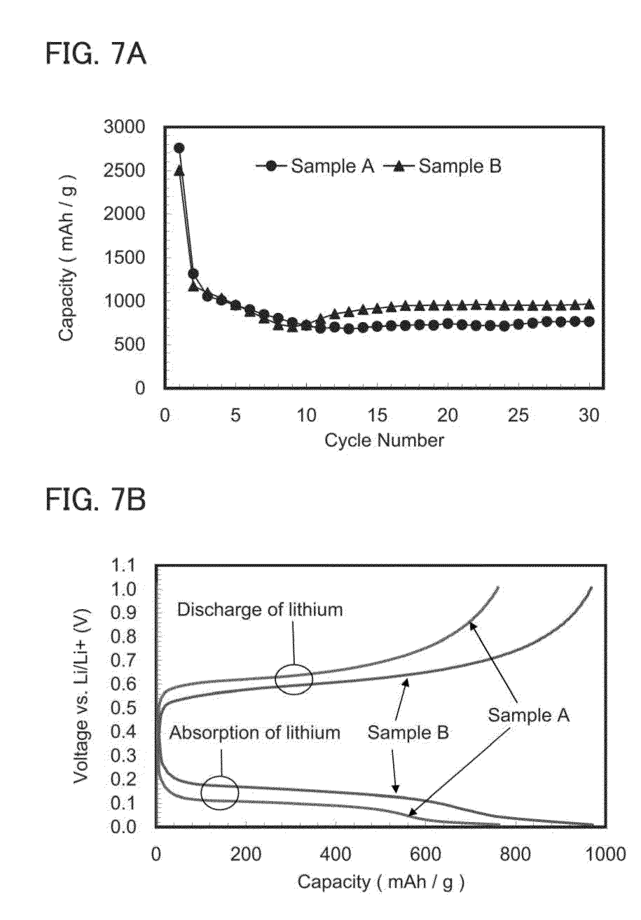

As shown in FIG. 7A, when discharge and absorption of lithium were repeated, the capacity of each of Sample A and Sample B was reduced; however, the capacity of Sample B was increased to be higher than that of Sample A in the tenth cycle and the subsequent cycles. FIG. 7B shows the relation between the capacity and a change in the potential which are associated with the discharge (or absorption) of lithium in the thirtieth cycle. FIG. 7B, shows that Sample B can discharge and absorb a larger amount of lithium than Sample A. This is probably because the SEI formed on Sample B was thin.

This application is based on Japanese Patent Application serial no. 2011-125224 filed with Japan Patent Office on Jun. 3, 2011 and Japanese Patent Application serial no. 2011-140307 filed with Japan Patent Office on Jun. 24, 2011, the entire contents of which are hereby incorporated by reference.

What is claimed is:

1. A negative electrode for a power storage device comprising:
an alloy-based negative electrode material particle or an alloy-based negative electrode material whisker; and
a carbon film including 1 to 50 graphene layers,
wherein a surface of the alloy-based negative electrode material particle or the alloy-based negative electrode material whisker is covered with the carbon film.

2. The negative electrode for a power storage device according to claim 1, wherein the alloy-based negative electrode material particle or the alloy-based negative electrode material whisker includes silicon.

3. The negative electrode for a power storage device according to claim 1, wherein the carbon film has at least one hole.

4. The negative electrode for a power storage device according to claim 1, wherein a proportion of elements except carbon and hydrogen in the carbon film is 15 at. % or less.

5. The negative electrode for a power storage device according to claim 1, further comprising one or a plurality of layers,
wherein the one or the plurality of layers is provided over the alloy-based negative electrode material particle or the alloy-based negative electrode material whisker, and
wherein a material of the one or the plurality of layers is different from a material of the carbon film.

6. A power storage device comprising a negative electrode, the negative electrode comprising:
an alloy-based negative, electrode material particle or an alloy-based negative electrode material whisker; and
a carbon film including 1 to 50 graphene layers,
wherein a surface of the alloy-based negative electrode material particle or the alloy-based negative electrode material whisker is covered with the carbon film.

7. The power storage device according to claim 6, wherein the alloy-based negative electrode material particle or the alloy-based, negative electrode material whisker includes silicon.

8. The power storage device according to claim 6, wherein the carbon film has at least one hole.

9. The power storage device according to claim 6, wherein a proportion of elements except carbon and hydrogen in the carbon film is 15 at. % or less.

10. The power storage device according to claim 6, further comprising one or a plurality of layers,
wherein the one or the plurality of layers is provided over the alloy-based negative electrode material particle or the alloy-based negative electrode material whisker, and
wherein a material of the one or the plurality of layers is different from a material of the carbon film.

11. A method of manufacturing a negative electrode, for a power-storage device, comprising the steps of:
mixing an alloy-based negative electrode material particle or an alloy-based negative electrode material whisker with graphene oxide; and
heating the mixture in a vacuum or in a reducing atmosphere.

12. The method of manufacturing a negative electrode for a power storage device according to claim 11,
wherein a carbon film including 1 to 50 graphene layers is formed by reducing the graphene oxide after the mixture is heated.

13. The method of manufacturing a negative electrode for a power storage device according to claim 11,
wherein a carbon film including 1 to 50 graphene layer is formed to cover a surface of the alloy-based negative electrode material particle or the alloy-based negative electrode material whisker after the mixture is heated.

14. A method of manufacturing a power storage device, comprising the steps of:
mixing an alloy-based negative electrode material particle or an alloy-based negative electrode material whisker with graphene oxide; and
heating the mixture in a vacuum or in a reducing atmosphere.

15. The method of manufacturing a power storage device according to claim 14,
wherein a carbon film including 1 to 50 graphene layers is formed by reducing the graphene oxide after the mixture is heated.

16. The method of manufacturing a power storage device according to claim 14,
wherein a carbon film including 1 to 50 graphene layers is formed to cover a surface of the alloy-based negative electrode material particle or the alloy-based negative electrode material whisker after the mixture is heated.

17. A method of manufacturing a power storage device, comprising the steps of:
immersing an alloy-based negative electrode material particle or an alloy-based negative electrode-material whisker in a solution in which graphene oxide is dispersed; and
heating the alloy-based negative electrode material particle or the alloy-based negative electrode material whisker in a vacuum or in a reducing atmosphere.

18. The method of manufacturing a power storage device according to claim 17,
wherein a carbon film including 1 to 50 graphene layers is formed by reducing the graphene oxide after the alloy-based negative electrode material particle or the alloy-based negative electrode material whisker is heated.

19. The method of manufacturing a power storage device according to claim 17,
wherein a carbon film including 1 to 50 graphene layers is formed to cover a surface of the alloy-based negative electrode material particle or the alloy-based negative electrode material whisker after the alloy-based negative electrode material particle or the alloy-based negative electrode material whisker is heated.

20. The method of manufacturing a power storage device according to claim 17, further comprising the step of applying a voltage between the alloy-based negative electrode material particle or the alloy-based negative electrode material whisker and an electrode immersed in the solution before the alloy-based negative electrode material particle or the alloy-based negative electrode material whisker is heated.
